(19) United States
(12) Patent Application Publication
(10) Pub. No.: US 2020/0286038 A1
(43) Pub. Date: Sep. 10, 2020

(54) INFORMATION PROCESSING DEVICE, INFORMATION PROCESSING METHOD, AND PROGRAM

(71) Applicant: Toyota Jidosha Kabushiki Kaisha, Toyota-shi (JP)

(72) Inventors: Keiji Yamashita, Nisshin-shi (JP); Hiromichi Dogishi, Nagoya-shi (JP); Masaki Shitara, Nagakute-shi (JP); Nozomi Kaneko, Nagoya-shi (JP); Naoki Yamamuro, Nagoya-shi (JP); Shunsuke Tanimori, Susono-shi (JP); Ryoichi Shiraishi, Anjo-shi (JP)

(73) Assignee: Toyota Jidosha Kabushiki Kaisha, Toyota-shi (JP)

(21) Appl. No.: 16/794,388

(22) Filed: Feb. 19, 2020

(30) Foreign Application Priority Data
Mar. 4, 2019 (JP) 2019-038470

(51) Int. Cl. G06Q 10/08; G07C 5/08; G05D 1/00

(52) U.S. Cl. CPC G06Q 10/08345; G05D 1/0088; G07C 5/0816

(57) ABSTRACT

A controller of an information processing device obtains a first capacity of a vehicle adapted to travel autonomously within a predetermined range, as a remaining capacity permitting one or more packages to be placed in the vehicle, sets a charge in the case where a first package that fits within the first capacity is transported by the vehicle, based on the first capacity, and outputs information concerning the charge and information concerning the first capacity, to a terminal of a user present within the predetermined range.

### INCORPORATION BY REFERENCE

The disclosure of Japanese Patent Application No. 2019-038470 filed on Mar. 4, 2019 including the specification, drawings and abstract is incorporated herein by reference in its entirety.

### BACKGROUND

### 1. Technical Field

The disclosure relates to an information processing device, an information processing method, and a program.

### 2. Description of Related Art

A system is known which confirms whether a mobile object that travels autonomously is able to deliver a package, when a method of delivering a package by use of the mobile object that travels autonomously is designated (see, for example, Japanese Unexamined Patent Application Publication No. 2018-124676 (JP 2018-124676 A)).

### SUMMARY

When packages are transported by a mobile object, the cost of transporting the packages may be increased if there is no package to be loaded on the vehicle, even though there is still space available for loading of packages on the mobile object. Thus, it is desirable to load as many packages as possible on the mobile object with substantially no space therebetween, when the packages are transported by the mobile object. The object of the disclosure is to enhance the efficiency in transportation of packages.

An information processing device according to a first aspect of the disclosure includes a controller configured to obtain a first capacity of a vehicle adapted to travel autonomously within a predetermined range, as a remaining capacity permitting one or more packages to be placed in the vehicle, set a charge in a case where a first package that fits within the first capacity is transported by the vehicle, based on the first capacity, and output information concerning the charge and information concerning the first capacity, to a terminal of a user present within the predetermined range.

An information processing method according to a second aspect of the disclosure includes obtaining a first capacity of a vehicle adapted to travel autonomously within a predetermined range by a computer, as a remaining capacity permitting one or more packages to be placed in the vehicle, setting a charge in a case where a first package that fits within the first capacity is transported by the vehicle, by the computer, based on the first capacity, and outputting information concerning the charge and information concerning the first capacity, to a terminal of a user present within the predetermined range, by the computer.

A program according to a third aspect of the disclosure causes a computer to execute: obtaining a first capacity of a vehicle adapted to travel autonomously within a predetermined range, as a remaining capacity permitting one or more packages to be placed in the vehicle, setting a charge in a case where a first package that fits within the first capacity is transported by the vehicle, based on the first capacity, and outputting information concerning the charge and information concerning the first capacity, to a terminal of a user present within the predetermined range.

According to the disclosure, it is possible to enhance the efficiency in transportation of packages.

### BRIEF DESCRIPTION OF THE DRAWINGS

Features, advantages, and technical and industrial significance of exemplary embodiments of the disclosure will be described below with reference to the accompanying drawings, in which like numerals denote like elements, and wherein:

FIG. 1 is a view schematically showing the configuration of a transportation system according to one embodiment;

FIG. 2 is a block diagram schematically showing one example of the configuration of each of a vehicle, user terminal, and server, which constitute the transportation system according to the embodiment;

FIG. 3 is a view showing one example of the functional configuration of the server;

FIG. 4 is a view showing a table structure of vehicle information by way of example;

FIG. 5 is a view showing a table structure of user information by way of example;

FIG. 6 is a view showing one example of the functional configuration of the vehicle;

FIG. 7 is a view showing one example of the functional configuration of the user terminal;

FIG. 8 is a view showing one example of a screen displayed on an output unit of the user terminal, when the user terminal receives charge information, etc. from the server;

FIG. 9 is a view showing a sequence of processing of the transportation system;

FIG. 10 is one example of a flowchart of a charge information providing process according to the embodiment; and

FIG. 11 is one example of a flowchart of an operation command generating process according to the embodiment.

### DETAILED DESCRIPTION OF EMBODIMENTS

The information processing device according to the first aspect of the disclosure obtains a first capacity of a vehicle. The first capacity represents the remaining capacity of the vehicle at the current point in time. Namely, the first capacity indicates the volume of the first package that can still be placed in the vehicle. The first capacity will also be referred to as “remaining capacity”. For example, when packages are placed in the vehicle with substantially no spaces therebetween, the remaining capacity is zero. If there is space in which the first package can be placed, the remaining capacity corresponding to its volume is obtained. The remaining capacity may be calculated, based on an image captured by a camera installed in the vehicle, for example, or may be calculated based on the size of the package entered by each user. The vehicle transports packages while traveling in a predetermined range. The predetermined range may be a range in which packages are scheduled to be delivered or collected by the vehicle, or a range in which packages can be delivered or collected by the vehicle, for example. Also, the predetermined range may be a range in which a burden on the vehicle is within a permissible range even if a route on which the vehicle moves is changed. The burden on the vehicle may be a burden in terms of time, burden in terms of cost, etc., for example. In the following description, the predetermined range will also be called “operation range”.

The controller may set a charge in the case where the vehicle transports the first package that fits within the remaining capacity, based on the remaining capacity. This charge is set to be cheaper than a standard charge, for example. The standard charge is set without regard to the remaining capacity, for example, and may be an undiscounted charge.

The controller outputs information concerning the charge set in the above manner, to a terminal of a user, along with information concerning the remaining capacity. The output may be executed according to a request from the user. The user who receives these items of information is one of users who are present in the predetermined range, and who have not requested transportation of packages. When the information concerning the charge is generated, the charge is displayed on the terminal possessed by each user, for example. Depending on the charge and the remaining capacity, the user may wish to have the first package transported. Thus, if the first package or packages fitting in the remaining capacity are collected in this manner, a larger number of packages can be transported at a time, and the efficiency in transportation of packages can be enhanced. As a result, the cost is reduced.

The controller may set the charge in the case where the first package is transported by the vehicle, such that the charge is reduced as the first capacity is larger.

If the charge associated with transportation of the first package is set such that the charge is reduced as the remaining capacity is larger, users are more easily collected, and the remaining capacity can be further reduced. Thus, the efficiency in transportation of packages can be enhanced.

When the controller receives information concerning a request to transport the first package by the vehicle, from the terminal of the user, the controller may generate an operation command for the vehicle such that the vehicle travels via a point corresponding to the user, and output the operation command generated, to the vehicle.

The point corresponding to the user is, for example, a location of the user, address of the user, or a point which the user wishes to use as a point at which the first package is to be placed in the vehicle. When the user wishes to have the first package transported by the vehicle, the controller generates an operation command for the vehicle, so that the vehicle can receive the first package from the user. When the vehicle moves according to the operation command, the vehicle can receive the first package from the user.

The controller may further output information concerning time of operation of the vehicle, to the terminal of the user.

Thus, the user can select a vehicle that permits the first package to be placed in the vehicle at a time when the user is at home, for example, so that the first package can be placed in the vehicle with higher reliability.

In the following, one embodiment of the disclosure will be described. The configuration of the embodiment below is merely exemplary, and the disclosure is not limited to the configuration of the embodiment. Also, the embodiment may be combined with other embodiments as far as possible.

Summary of Transportation System

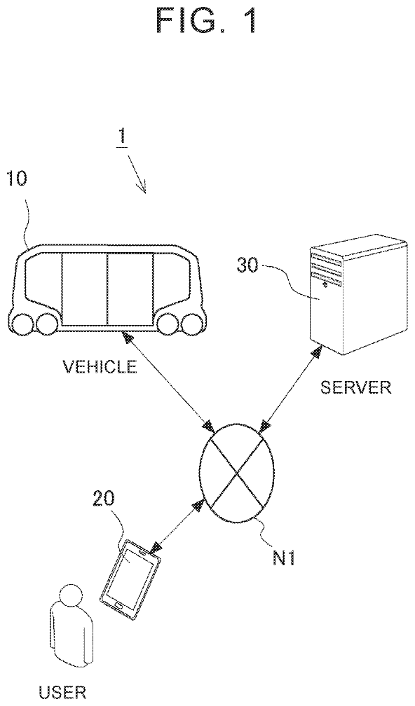

FIG. 1 schematically shows the configuration of a transportation system 1 according to one embodiment. The transportation system 1 includes a vehicle 10, user terminal 20, and server 30, for example. The vehicle 10, user terminal 20, and server 30 are connected to each other via a network N1. For example, the network N1 is a worldwide, public telecommunication network, such as the Internet, and may adopt Wide Area Network (WAN) and other communication networks. The network N1 may also include a telephone communication network, such as mobile phones, and a wireless network, such as Wi-Fi. The number of the vehicle or vehicles 10 is not limited to one as illustrated in FIG. 1, but may be two or more. The vehicle 10 is able to travel autonomously, based on an operation command generated by the server 30. The vehicle 10 is configured to be able to deliver and pick up packages. In the transportation system 1 shown in FIG. 1, when the user requests transportation of a package, via the user terminal 20, the server 30 generates an operation command for the vehicle 10, so that the vehicle 10 travels autonomously to receive the package from the user, and transports the package.

There may be two or more users who request pickup of packages. In the case that will be described below, the vehicle 10 is already loaded with packages requested by other users to be transported, and the vehicle 10 is in the middle of transporting the packages.

The server 30 generates an operation command for the vehicle 10, by setting delivery locations and pickup locations of packages as transit points of the vehicle 10, so as to cause the vehicle 10 to transport the packages. The operation command generated by the server 30 is transmitted from the server 30 to the vehicle 10. The vehicle 10 that has received the operation command travels autonomously, according to the operation command.

The server 30 sets a charge for transporting a package that is fitted in the remaining capacity of the vehicle 10, based on the remaining capacity. The server 30 sends information concerning the remaining capacity of the vehicle 10, and information concerning charge, to the user terminal 20 present in a predetermined range. At this time, the server 30 may also send information concerning the time of operation of the vehicle 10, to the user terminal 20. When the server 30 receives a request to transport a package, from the user terminal 20, the server 30 generates an operation command for the vehicle 10 so that the vehicle 10 receives the package from the user corresponding to the user terminal 20, and sends the operation command to the vehicle 10. The vehicle 10 that has received the operation command travels according to the operation command, and receives the package from the user. This package is transported to a location designated by the user, for example.

The predetermined range within which the server 30 sends information concerning charge, etc. to is determined in advance as a range in which the vehicle 10 can deliver and pick up packages, for example. The predetermined range may also be set as a range in which the vehicle 10 can travel around from this point in time, based on position information of the vehicle 10. When the server 30 receives a request to transport a package from the user, after sending the information concerning charge, the server 30 changes a route on which the vehicle 10 moves, so that the vehicle 10 receives the package from the user. The charge for transporting a package is set by the server 30, such that the charge is reduced as the remaining capacity is larger, for example. Accordingly, when the vehicle 10 receives a package from a user, and the remaining capacity is reduced, another user who subsequently requests shipping may be charged more within a range equal to or lower than a standard charge.

Hardware Configuration

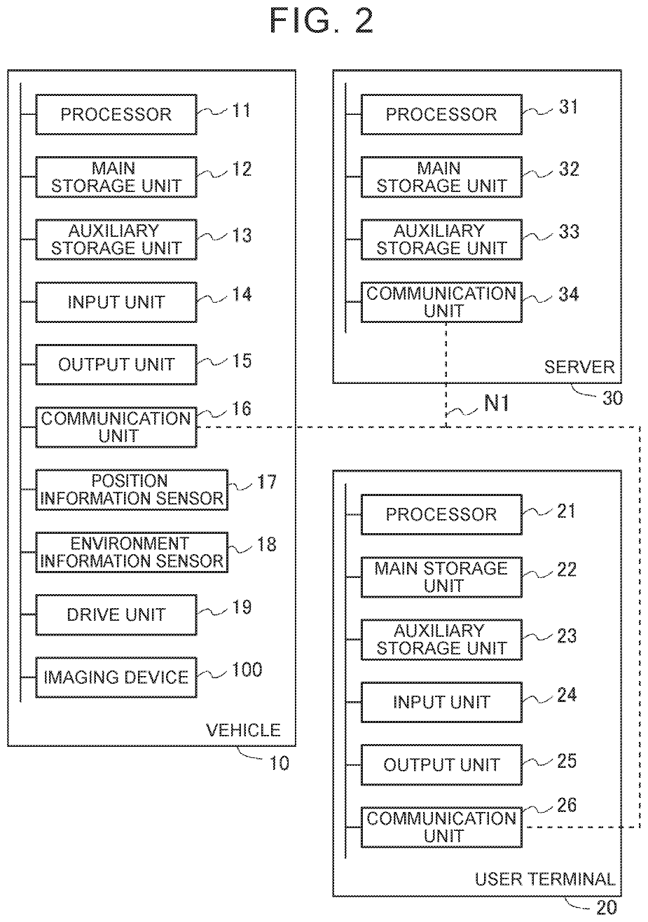

Referring to FIG. 2, the hardware configuration of the vehicle 10, user terminal 20, and server 30 will be described. FIG. 2 is a block diagram schematically showing one example of the configuration of each of the vehicle 10, user terminal 20, and server 30 that constitute the transportation system 1 according to this embodiment.

The server 30 has the configuration of a general computer. The server 30 has a processor 31, main storage unit 32, auxiliary storage unit 33, and communication unit 34. These components are connected to each other via a bus. The server 30 is one example of the information processing device.

The processor 31 is a central processing unit (CPU), or digital signal processor (DSP), for example. The processor 31 controls the server 30, and performs various computations of information processing. The processor 31 is one example of the “controller”. The main storage unit 32 is a random access memory (RAM), or read-only memory (ROM), for example. The auxiliary storage unit 33 is an erasable programmable read-only memory (EPROM), hard disc drive (HDD), removable media, or the like. The auxiliary storage unit 33 stores an operating system (OS), various programs, various tables, and so forth. The processor 31 loads a program stored in the auxiliary storage unit 33, into a working area of the main storage unit 32, and executes the program, so as to control each constituent unit, etc. of the server 30. In this manner, the server 30 implements functions that meet given objectives. The main storage unit 32 and auxiliary storage unit 33 are computer-readable recording media. The server 30 may be a single computer, or may consist of two or more computers that are linked together. Information stored in the auxiliary storage unit 33 may be stored in the main storage unit 32. Also, information stored in the main storage unit 32 may be stored in the auxiliary storage unit 33.

The communication unit 34 is a means for communicating with the vehicle 10 and the user terminal 20 via the network N1. The communication unit 34 is, for example, LAN (Local Area Network) interface board, or a wireless communication circuit for wireless communications. The LAN interface board or wireless communication circuit is connected to the network N1.

A series of tasks performed in the server 30 may be performed by hardware, or may be performed by software. The hardware configuration of the server 30 is not limited to the one shown in FIG. 2. Also, a part or the whole of the configuration of the server 30 may be installed on the vehicle 10.

Next, the vehicle 10 will be described. The vehicle 10 has a processor 11, main storage unit 12, auxiliary storage unit 13, input unit 14, output unit 15, communication unit 16, position information sensor 17, environment information sensor 18, drive unit 19, and imaging device 100. These components are connected to each other via a bus. The processor 11, main storage unit 12, and auxiliary storage unit 13 are similar to the processor 31, main storage unit 32, and auxiliary storage unit 33 of the server 30, respectively, and thus will not be described herein.

The input unit 14 is a means for accepting input operation performed by the user, and is in the form of a touch panel, push buttons, etc., for example. The output unit 15 is a means for presenting information to the user, and is in the form of a liquid crystal display (LCD), electroluminescence (EL) panel, speaker, lamp, etc., for example.

The input unit 14 and output unit 15 may be formed as a single touch panel display. The communication unit 16 is a communicating means for connecting the vehicle 10 with the network N1. The communication unit 16 is a circuit for conducting communications with other devices (e.g., the server 30), via the network N1, using a mobile communications service (e.g., telephone communication network, such as 3rd Generation (3G) or Long Term Evolution (LTE), or wireless communications, such as Wi-Fi).

The position information sensor 17 obtains the position information (e.g., latitude and longitude) of the vehicle 10, at predetermined intervals. The position information sensor 17 is a GPS (Global Positioning System) receiver, Wi-Fi communication unit, etc., for example. The information obtained by the position information sensor 17 is stored in the auxiliary storage unit 13, for example, and transmitted to the server 30.

The environment information sensor 18 is a means for sensing conditions of the vehicle 10 and sensing the vicinity of the vehicle 10. Examples of sensors for sensing conditions of the vehicle 10 include an acceleration sensor, speed sensor, azimuth sensor, and so forth. Examples of sensors for sensing the vicinity of the vehicle 10 include a stereo camera, laser scanner, LIDAR (Light Imaging Detection and Ranging), radar, and so forth.

The drive unit 19 causes the vehicle 10 to travel, based on a control command generated by the processor 11. The drive unit 19 includes a motor and an inverter for driving wheels included in the vehicle 10, brake system, steering mechanism, and so forth, and the motor, brake system, etc. are driven according to the control command, so that the vehicle 10 achieves autonomous traveling.

The imaging device 100 is provided in a cargo compartment of the vehicle 10, and captures an image of the interior of the cargo compartment. The imaging device 100 is a camera that captures images, using an image pickup device, such as a CCD (Charge-Coupled Device) image sensor or CMOS (Complementary Metal Oxide Semiconductor) image sensor, for example. The images captured by the imaging device 100 may be still images or video. In this embodiment, the imaging device 100 is adapted to capture still images.

Next, the user terminal 20 will be described. The user terminal 20 is a small computer, such as a smartphone, mobile phone, tablet terminal, personal information terminal, wearable computer (such as a smart watch), or personal computer (PC). The user terminal 20 has a processor 21, main storage unit 22, auxiliary storage unit 23, input unit 24, output unit 25, and communication unit 26. These components are connected to each other via a bus. The processor 21, main storage unit 22, auxiliary storage unit 23, input unit 24, output unit 25, and communication unit 26 are similar to the processor 11, main storage unit 12, auxiliary storage unit 13, input unit 14, output unit 15 and communication unit 16 of the vehicle 10, and thus will not be described herein. The user terminal 20 may be a single computer, or may consist of two or more computers linked together.

Functional Configuration: Server

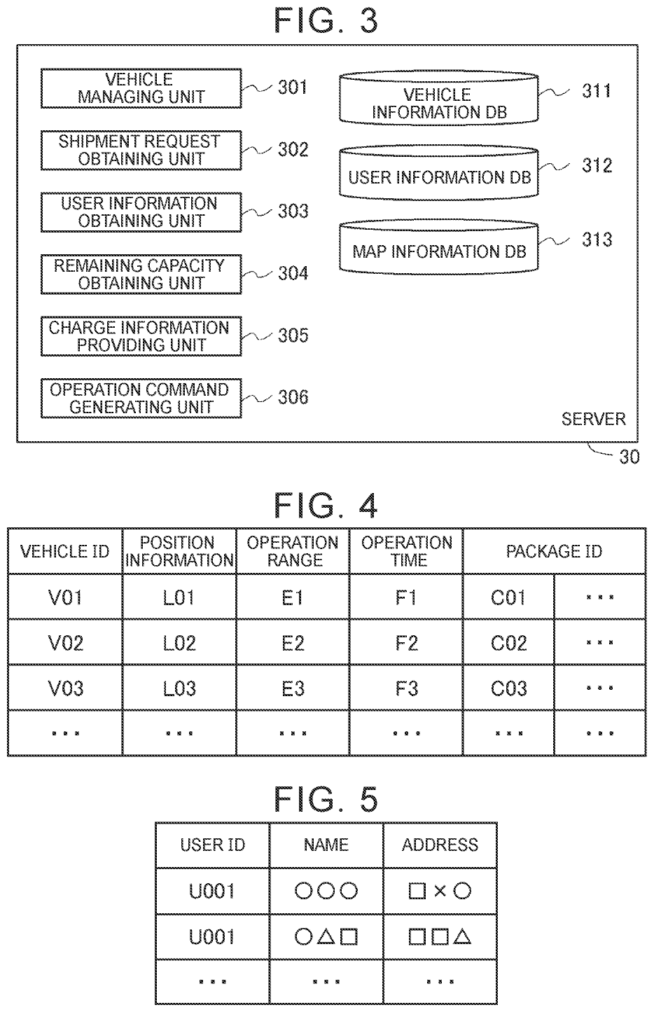

FIG. 3 shows one example of the functional configuration of the server 30. The server 30 includes a vehicle managing unit 301, shipment request obtaining unit 302, user information obtaining unit 303, remaining capacity obtaining unit 304, charge information providing unit 305, operation command generating unit 306, vehicle information database (DB) 311, user information DB 312, and map information DB 313, as functional constituent elements. The vehicle managing unit 301, shipment request obtaining unit 302, user information obtaining unit 303, remaining capacity obtaining unit 304, charge information providing unit 305, and operation command generating unit 306 are functional constituent elements provided when the processor 31 of the server 30 executes various programs stored in the auxiliary storage unit 33, for example.

The vehicle information DB 311, user information DB 312, and map information DB 313 provide a relational database, for example, which is constructed by managing data stored in the auxiliary storage unit 33, according to a program of a database management system (DBMS) executed by the processor 31. Any of the functional constituent elements of the server 30, or a part of its tasks, may be implemented by another computer connected to the network N1.

The vehicle managing unit 301 manages a variety of information concerning the vehicle 10. The vehicle managing unit 301 obtains and manages position information transmitted from the vehicle 10 at predetermined intervals, or position information transmitted from the vehicle 10 in response to a request from the server 30, for example. The vehicle managing unit 301 associates the position information with a vehicle ID, and stores the resulting information in the vehicle information DB 311. The vehicle ID is an identifier specific to the vehicle 10. Also, the vehicle managing unit 301 manages information concerning an ID (which will also be called “package ID”) corresponding to a package placed in the vehicle 10. The package ID is a package-specific identifier, and is linked with a user ID. The user ID is a user-specific identifier.

The shipment request obtaining unit 302 obtains a shipment request from the user terminal 20 of the user who wishes to have a package transported, for example. The shipment request is information including an identifier of the user, and information for requesting pickup of a package by the vehicle 10 for the purpose of shipping the package from the user. The shipment request may be referred to as information concerning a wish to transport a package by means of the vehicle 10. The shipment request includes information concerning the user ID, and information concerning an identifier (which will also be called “vehicle ID”) specific to the vehicle 10 requested by the user to pick up the package. When the shipment request obtaining unit 302 obtains the shipment request, it assigns a package ID to the package corresponding to the shipment request.

The user information obtaining unit 303 obtains information (user information) of the user corresponding to each of the user terminals 20, for example. The user information includes information concerning the user ID, name, address, etc. linked with the user, for example. The user information is transmitted from the user terminal 20 to the server 30. When the user information obtaining unit 303 obtains user information, it stores the user information in the user information DB 312 that will be described later.

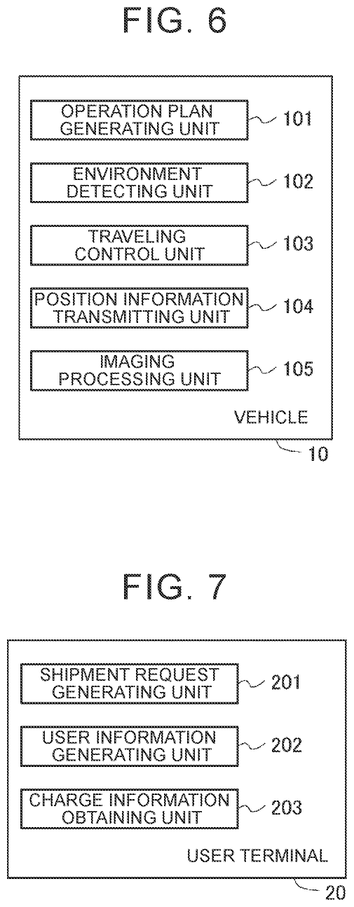

The remaining capacity obtaining unit 304 obtains information concerning the remaining capacity of the vehicle 10. The remaining capacity is calculated based on an image captured by the imaging device 100 of the vehicle 10. This image is transmitted from an imaging processing unit 105 (see FIG. 6) of the vehicle 10 to the server 30, and is stored in the auxiliary storage unit 33. Known technologies may be used for calculating the remaining capacity. While the remaining capacity is calculated based on the captured image of the cargo compartment of the vehicle 10 in this embodiment, the method of calculating the remaining capacity is not limited to this method. For example, the user may enter the size of a package into the user terminal 20 upon shipping of the package, and the remaining capacity may be calculated based on this information. Also, the vehicle 10 may be provided with a sensor for detecting the remaining capacity, and the remaining capacity of the vehicle 10 may be calculated based on an output value of this sensor. The remaining capacity may be calculated when an inquiry about it is received from the user (or a request for it is received from the user), or when the cargo compartment is photographed by the imaging device 100 of the vehicle 10.

The charge information providing unit 305 computes a charge in the case where the user requests transportation of a package by the vehicle 10 at the current point in time, according to the remaining capacity at the current point in time. The charge is computed with respect to each vehicle 10. For example, the charge may be reduced as the remaining capacity is larger. The charge may be changed in stages according to the remaining capacity. Also, the charge set according to the remaining capacity is set to a lower charge than a standard charge. The standard charge, which is an undiscounted charge, is set without regard to the remaining capacity. The relationship between the remaining capacity and the charge is stored in the auxiliary storage unit 33. Then, the charge information providing unit 305 searches for users whose addresses are within a predetermined range. Then, the charge information providing unit 305 sends information (charge information) concerning the charge, information concerning the remaining capacity, and information concerning the operation time, to the user terminal 20 of each of the users thus searched for. The vehicle ID is linked with these items of information.

The operation command generating unit 306 generates an operation command to cause the vehicle 10 to start from a point of departure, make stops at package delivery locations and pickup locations, and return to the point of departure, for example. The operation command generating unit 306 generates a moving route based on map information stored in the map information DB 313 that will be described later. Known technologies may be used for generating the moving route. For example, the moving route is generated according to a predetermined rule, such that the travel distance of the vehicle 10 is minimized, or the travel time of the vehicle 10 is minimized. The operation command generating unit 306 sends the operation command thus generated, to the vehicle 10. Also, when the server 30 receives a shipment request from the user terminal 20, the operation command generating unit 306 generates an operation command to cause the vehicle 10 to move to a pickup location of a package associated with the shipment request, and place the package in the vehicle 10 at the pickup location.

The vehicle information DB 311 is formed by storing vehicle information in the auxiliary storage unit 33, and the vehicle information is linked with the vehicle ID in the vehicle information DB 311. Here, the structure of the vehicle information stored in the vehicle information DB 311 will be described based on FIG. 4. FIG. 4 shows the table structure of the vehicle information by way of example. The vehicle information table has each field of the vehicle ID, position information, operation range, operation time, and package ID. In the vehicle ID field, identification information (information indicating the vehicle ID) that specifies the vehicle 10 is entered. In the position information field, position information transmitted from the vehicle 10 is entered. The position information indicates the current location of the vehicle 10. In the operation range field, information concerning a range in which the vehicle 10 delivers and picks up packages is entered. The range in which delivery and pickup are conducted corresponds to the above-mentioned predetermined range, and will also be called “operation range”. In the operation time field, information concerning times at which the vehicle 10 delivers and picks up packages, namely, operation times, is entered. In the package ID field, information indicating the package ID is entered. The information concerning the operation range corresponding to each vehicle 10 and the information concerning the operation time are entered in advance. The package ID is linked with the user ID, delivery location, and pickup location.

The user information DB 312 is formed by storing user information in the auxiliary storage unit 33, and the user information is linked with the user ID in the user information DB 312. Here, the structure of the user information stored in the user information DB 312 will be described based on FIG. 5. FIG. 5 shows the table structure of the user information by way of example. The user information table has each field of the user ID, name, and address. In the user ID field, identification information (information concerning the user ID) for specifying the user is entered. In the name field, information concerning the name of the user is entered. In the address field, information (which will be called “address information”) concerning the address of the user is entered. The address of the user is used as a package delivery location or pickup location.

The map information DB 313 stores map information including map data, and POI (Point of Interest) information, such as letters, photographs, etc., indicating characteristics of each point on the map data. The map information DB 313 may be provided from another system, such as a geographic information system (GIS), which is connected to the network N1.

Functional Configuration: Vehicle

FIG. 6 shows one example of the functional configuration of the vehicle 10. The vehicle 10 includes an operation plan generating unit 101, environment detecting unit 102, traveling control unit 103, position information transmitting unit 104, and imaging processing unit 105, as functional constituent elements. The operation plan generating unit 101, environment detecting unit 102, traveling control unit 103, position information transmitting unit 104, and imaging processing unit 105 are functional constituent elements provided by the processor 11 of the vehicle 10 when it executes various programs stored in the auxiliary storage unit 13.

The operation plan generating unit 101 obtains the operation command from the server 30, and generates an operation plan of the vehicle 10. The operation command includes information concerning transit points at which the vehicle 10 makes brief stops. The operation plan generating unit 101 calculates the moving route of the vehicle 10, based on the operation command supplied from the server 30, and generates the operation plan according to which the vehicle 10 travels on the moving route.

The environment detecting unit 102 detects an environment surrounding the vehicle 10, which is needed for autonomous traveling, based on data obtained by the environment information sensor 18. Objects of detection include, for example, the number and positions of traffic lanes, the number and positions of other mobile objects present around the vehicle 10, the number and positions of obstacles (such as a pedestrian, bicycle, structure, and construction) present around the vehicle 10, structure of a road, road signs, and so forth, but are not limited to these. The object of detection may be anything, provided that it is needed for autonomous traveling of the vehicle 10. When the environment information sensor 18 is a stereo camera, for example, objects around the vehicle 10 are detected by performing image processing on image data captured by the stereo camera. Data (which will be called “environment data”) concerning the surrounding environment of the vehicle 10, which is detected by the environment detecting unit 102, is transmitted to the traveling control unit 103 that will be described below.

The traveling control unit 103 generates a control command for controlling autonomous traveling of the vehicle 10, based on the operation plan generated by the operation plan generating unit 101, environment data generated by the environment detecting unit 102, and position information of the vehicle 10 obtained by the position information sensor 17. For example, the traveling control unit 103 generates a control command to cause the vehicle 10 to travel along a predetermined route, such that no obstacle enters a predetermined safety region around the vehicle 10. The control command thus generated is transmitted to the drive unit 19. A method of generating the control command to autonomously move the vehicle 10 may be selected from known methods.

The position information transmitting unit 104 sends position information obtained from the position information sensor 17, to the server 30, via the communication unit 16. The timing of transmission of the position information from the position information transmitting unit 104 may be set as appropriate; for example, the position information may be transmitted on a regular basis, or may be transmitted at times when it sends some information to the server 30, or may be transmitted in response to a request from the server 30. The position information transmitting unit 104 sends the position information to the server 30, along with identification information (vehicle ID) that uniquely identifies the self-vehicle. The vehicle ID that identifies the vehicle 10 is assigned to the vehicle 10 in advance.

The imaging processing unit 105 controls the imaging device 100, to photograph the interior of the cargo compartment of the vehicle 10 at predetermined points in time. The predetermined points in time may include, for example, a time when a package is placed in the vehicle 10, a time when a package is unloaded from the vehicle 10, a time when the vehicle 10 starts from a delivery location or pickup location, a time when a door of the cargo compartment of the vehicle 10 is closed, a time when photographing is requested from the server 30, and so forth. The imaging processing unit 105 stores an image captured by the imaging device 100, in the auxiliary storage unit 13. Also, the imaging processing unit 105 sends the image captured by the imaging device 100, to the server 30, via the communication unit 16.

Functional Configuration: User Terminal

Next, the functions of the user terminal 20 will be described. FIG. 7 shows the functional configuration of the user terminal 20 by way of example. The user terminal 20 includes a shipment request generating unit 201, user information generating unit 202, and charge information obtaining unit 203, as functional constituent elements. The shipment request generating unit 201, user information generating unit 202, and charge information obtaining unit 203 are functional constituent elements provided by the processor 21 of the user terminal 20 when it executes various programs stored in the auxiliary storage unit 23, for example. It is, however, to be noted that any of the functional constituent elements or a part of its tasks may be implemented by a hardware circuit.

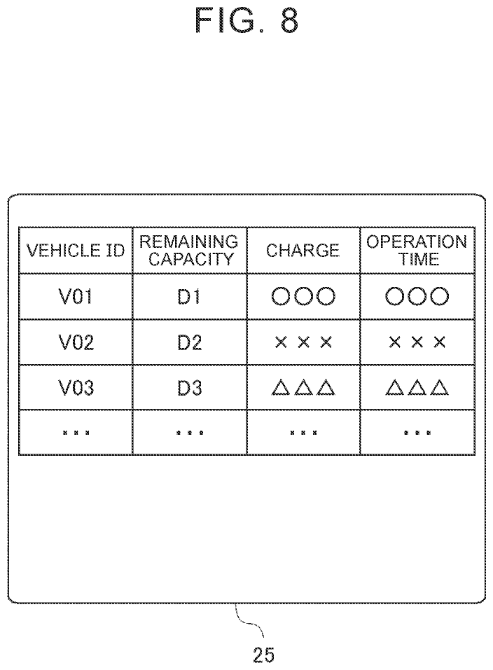

The shipment request generating unit 201 outputs an operation screen on the output unit 25, for example, and generates a shipment request according to input by the user into the input unit 24. FIG. 8 shows one example of a screen displayed on the output unit 25 of the user terminal 20, when the user terminal 20 receives charge information, etc. from the server 30. On the output unit 25, the vehicle ID, remaining capacity, charge, and operation time, which correspond to the vehicle 10 that can pick up a package at the address of the user, are displayed. This screen is generated based on charge information which the charge information obtaining unit 203 that will be described later receives from the server 30. For example, when the user clicks any of the vehicle IDs displayed on the screen, the shipment request generating unit 201 generates a shipment request. The shipment request generating unit 201 sends the shipment request thus generated, to the server 30. The shipment request includes information concerning the user ID stored in the auxiliary storage unit 23 of the user terminal 20, and information concerning the vehicle ID corresponding to the vehicle 10 selected by the user.

The user information generating unit 202 generates user information. The user information generating unit 202 displays an operation screen that prompts entry of user information (e.g., name, address) on the output unit 25, and generates user information according to the entry into the input unit 24 by the user. The user information generating unit 202 links the user information thus generated, with the user ID, and sends the resulting information to the server 30. The user may enter the user information in advance, using the input unit 24, and the user information may be stored in the auxiliary storage unit 23 of the user terminal 20. Then, the user information generating unit 202 may generate user information, based on data stored in the auxiliary storage unit 23. Also, the user information generating unit 202 may generate user information when each user signs up as a user, for example, and may send the user information thus generated, to the server 30. In this case, the user information is stored in advance in the user information DB 312 of the server 30.

The charge information obtaining unit 203 obtains charge information, information concerning the remaining capacity, and information concerning the operation time, which are transmitted from the server 30. The charge information, information concerning the remaining capacity, and information concerning the operating time, which are obtained by the charge information obtaining unit 203, are stored in the auxiliary storage unit 23, and also transmitted to the shipment request generating unit 201. The charge information obtaining unit 203 may have a function of requesting the server 30 to transmit charge information and information concerning the remaining capacity.

Flow of Processing: System

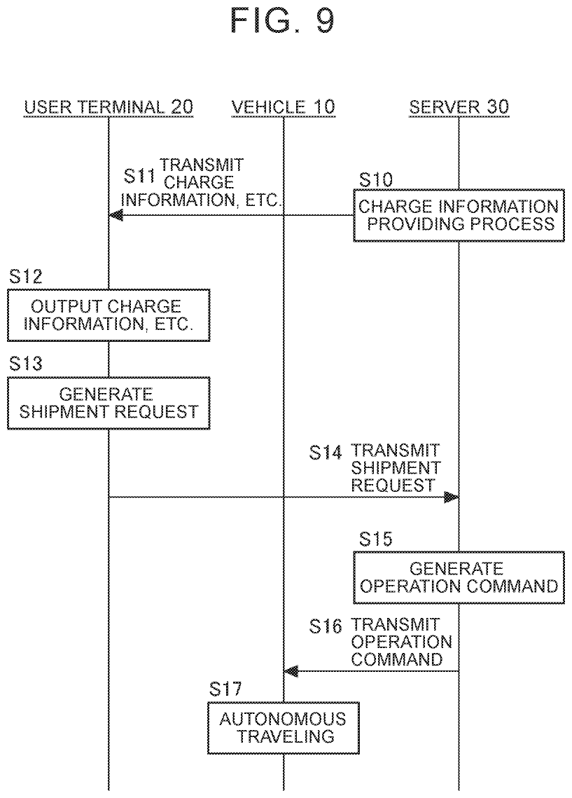

Next, operation of the transportation system 1 will be described. FIG. 9 shows a sequence of processing of the transportation system 1. In the sequence diagram shown in FIG. 9, the user information is transmitted in advance from each user terminal 20, and the position information of the vehicle 10 is transmitted to the server 30 at predetermined time intervals. Also, the vehicle 10 is already loaded with packages of other users, and the vehicle 10 travels autonomously.

In S10, the server 30 performs a process of providing charge information. The charge information providing process will be described later. Once the charge information providing process is completed, the charge information and information concerning the remaining capacity (which will also be called “charge information, etc.”) are transmitted from the server 30 to the user terminal 20 (task of S11). The user terminal 20 that has received the charge information, etc. outputs an image corresponding to the charge information, on the output unit 25, as shown in FIG. 8 (task of S12).

With the charge generated to the user terminal 20, the user can be informed of the charge at the current time when shipping a package. Also, with the remaining capacity generated to the user terminal 20, the user can determine whether a package of the user can be placed in the vehicle 10. Then, when the user requests pickup of the package, the user clicks a vehicle ID displayed on the screen of the user terminal 20, for example. Then, the user terminal 20 generates a shipment request (task of S13). The shipment request is transmitted from the user terminal 20 to the server 30 in S14 (task of S14). The server 30 that has received the shipment request generates an operation command for the vehicle 10, based on information concerning the user ID and information concerning the vehicle ID, which are included in the received shipment request (task of S15). The operation command is generated so that the vehicle 10 moves the shortest distances to package delivery locations and pickup locations, for example. The operation command thus generated is transmitted from the server 30 to the vehicle 10 (task of S16). The vehicle 10 that has received the operation command travels autonomously according to the operation command (task of S17).

Flow or Processing: Server

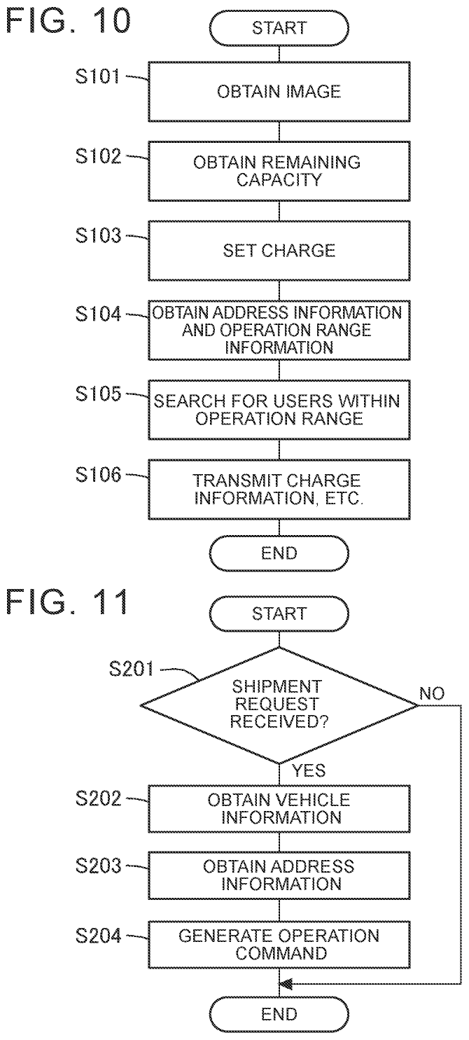

Next, the charge information providing process performed in S10 of the sequence diagram shown in FIG. 9 will be described. FIG. 10 is one example of a flowchart of the charge information providing process according to this embodiment. The charge information providing process shown in FIG. 10 is performed by the remaining capacity obtaining unit 304 and charge information providing unit 305 at predetermined time intervals, with respect to each vehicle 10. The charge information providing process may also be performed with respect to a certain vehicle 10, each time the vehicle 10 receives a package or delivers a package. In this example, the server 30 already receives information necessary to construct the vehicle information DB 311 and the user information DB 312, from the vehicle 10 and the user terminal 20.

In step S101, the remaining capacity obtaining unit 304 obtains an image of the cargo compartment of the vehicle 10 from the auxiliary storage unit 33. In step S102, the remaining capacity obtaining unit 304 obtains the remaining capacity, based on the obtained image. To calculate the remaining capacity, a predetermined program stored in the auxiliary storage unit 33 is used. In step S103, the charge information providing unit 305 sets charge. The charge information providing unit 305 calculates and sets charge required to transport a package at the current time, based on the remaining capacity. Also, the charge information providing unit 305 generates charge information based on the result of calculation of charge. In step S104, the charge information providing unit 305 obtains information (address information) concerning the addresses of users stored in the user information DB 312, information (operation range information) concerning the operation range of the vehicle 10 and information (operation time information) concerning the operation time thereof, which are stored in the vehicle information DB 313.

Then, in step S105, the charge information providing unit 305 searches for users whose addresses are located in the operation range of the vehicle 10, based on the address information and operation range information obtained in step S104. The charge information providing unit 305 picks all users whose addresses are located in the operation range, based on the user address information. Then, in step S106, the charge information providing unit 305 links the information concerning the remaining capacity and obtained in step S102, charge information generated in step S103, and operation time information obtained in step S104, with the corresponding vehicle ID, and sends these items of information to the user terminals 20 corresponding to the users picked in step S104. Then, the process shown in FIG. 10 is completed.

Next, the operation command generating process performed in S15 of the sequence diagram shown in FIG. 9 will be described. FIG. 11 is one example of a flowchart of the operation command generating process according to this embodiment. The process shown in FIG. 11 is executed at predetermined time intervals, by the shipment request obtaining unit 302 and operation command generating unit 306 of the server 30. In this example, the server 30 has already received information necessary to construct the vehicle information DB 311 and the user information DB 312, from the vehicle 10 and the user terminal 20.

In step S201, the shipment request obtaining unit 302 determines whether it has received a shipment request from the user terminal 20. When an affirmative decision (YES) is obtained in step S201, the control proceeds to step S202. When a negative decision (NO) is obtained in step S201, the current cycle of this routine ends. In step S202, the operation command generating unit 306 obtains vehicle information from the vehicle information DB 311. In this embodiment, since the vehicle 10 has already been traveling, the position information of the vehicle 10 is obtained in step S202. Also, a delivery location or pickup location linked with the package ID is obtained. In step S203, the operation command generating unit 306 obtains address information of the user corresponding to the user terminal 20 that transmitted the shipment request. Then, in step S204, the operation command generating unit 306 generates an operation command, based on the vehicle information obtained in step S202 and the address information obtained in step S203. Then, the operation command generating unit 306 sends the operation command thus generated, to the vehicle 10. The operation command generating unit 306 may calculate the arrival time at which the vehicle 10 is supposed to arrive at the address of each user, based on the operation command, and send the time to the corresponding user terminal 20.

As described above, according to this embodiment, when the vehicle 10 that travels autonomously is used for transporting packages, and the vehicle 10 still have space in which additional packages can be placed, the charge for transportation is reduced, thus making it easier to collect packages to be placed in the space. It is thus possible to reduce or eliminate wasteful space, and improve the efficiency in transportation of packages.

### Other Embodiments

The above embodiment is a mere example, and the disclosure may be embodied with changes as needed, without departing from the principle of the disclosure.

The processes and means described above in this disclosure can be freely combined and implemented, provided that the combination gives rise to no technical inconsistencies.

Also, a process described as being performed by a single device may be divided and performed by two or more devices. As an alternative, processes described as being performed by different devices may be performed by a single device. In a computer system, the type of hardware configuration (server configuration) that implements each function may be flexibly changed. While the server 30 is illustrated as an example of the information processing device in the above embodiment, the information processing device is not limited to this, but the vehicle 10 may function as the information processing device, or the user terminal 20 may function as the information processing device. Also, the server 30, and the vehicle 10 or user terminal 20, may cooperate to function as the information processing device. In the above embodiment, the server 30 includes the vehicle managing unit 301, shipment request obtaining unit 302, user information obtaining unit 303, remaining capacity obtaining unit 304, charge information providing unit 305, operation command generating unit 306, vehicle information DB 311, user information DB 312, and map information DB 313, as functional constituent elements. However, a part or all of these functional constituent elements may be included in the vehicle 10. For example, the vehicle 10 may calculate the remaining capacity.

This disclosure may be practiced by supplying a computer program for implementing the functions described in the above embodiment, to a computer, and causing one or more processors included in the computer to read and run the program. The computer program may be provided to the computer, via a non-temporary computer-readable storage medium that can be connected to a system bus of the computer, or may be provided to the computer via a network. Examples of the non-temporary computer-readable storage medium include, for example, any types of disks, such as magnetic disks (floppy disk (registered trademark), hard disk drive (HDD), etc.), and optical disks (CD-ROM, DVD, blue-ray disk, etc.), read-only memory (ROM), random access memory (RAM), EPROM, electrically erasable programmable read-only memory (EEPROM), magnetic card, flash memory, optical card, and any types of media suitable for storing electronic commands.

What is claimed is:

1. An information processing device comprising a controller configured to:
obtain a first capacity of a vehicle adapted to travel autonomously within a predetermined range, as a remaining capacity permitting one or more packages to be placed in the vehicle;
set a charge in a case where a first package that fits within the first capacity is transported by the vehicle, based on the first capacity; and
output information concerning the charge and information concerning the first capacity, to a terminal of a user present within the predetermined range.

2. The information processing device according to claim 1, wherein the controller is configured to set the charge in the case where the first package is transported by the vehicle, such that the charge is reduced as the first capacity is larger.

3. The information processing device according to claim 1, wherein:
the controller is configured to generate an operation command for the vehicle such that the vehicle travels via a point corresponding to the user, when the controller receives information concerning a request to transport the first package by the vehicle, from the terminal of the user; and
the controller is configured to output the operation command generated, to the vehicle.

4. The information processing device according to claim 1, wherein the controller is configured to further output information concerning time of operation of the vehicle, to the terminal of the user.

5. An information processing method comprising:
obtaining a first capacity of a vehicle adapted to travel autonomously within a predetermined range by a computer, as a remaining capacity permitting one or more packages to be placed in the vehicle;
setting a charge in a case where a first package that fits within the first capacity is transported by the vehicle, by the computer, based on the first capacity; and
outputting information concerning the charge and information concerning the first capacity, to a terminal of a user present within the predetermined range, by the computer.

6. A program that causes a computer to execute:
obtaining a first capacity of a vehicle adapted to travel autonomously within a predetermined range, as a remaining capacity permitting one or more packages to be placed in the vehicle;
setting a charge in a case where a first package that fits within the first capacity is transported by the vehicle, based on the first capacity; and
outputting information concerning the charge and information concerning the first capacity, to a terminal of a user present within the predetermined range.
